(19) United States
(12) Patent Application Publication
(10) Pub. No.: US 2024/0220871 A1
(43) Pub. Date: Jul. 4, 2024

(54) SYSTEM OF AND METHOD FOR PERSONALIZED HEALTH-BASED TRAVEL

(71) Applicants: Chaithanya Renduchintala, Orlando, FL (US); University of Central Florida Research Foundation, Inc., Orlando, FL (US)

(72) Inventors: Robertico Croes, Orlando, FL (US); Dexter Hadley, Orlando, FL (US); Chaithanya Renduchintala, Orlando, FL (US)

(21) Appl. No.: 18/403,347

(22) Filed: Jan. 3, 2024

Related U.S. Application Data
(60) Provisional application No. 63/436,780, filed on Jan. 3, 2023.

(51) Int. Cl. G06Q 10/02; G06Q 50/14

(52) U.S. Cl. CPC G06Q 10/02; G06Q 50/14

(57) ABSTRACT

Described herein relates to a system of and method for providing and booking a personalized health-based travel itinerary. The invention may comprise an integrated travel platform which may be configured to present a score computed by a multifactorial AI based decision support algorithm which draws data sets from curated public and private data sources in real time basis. Additionally, the integrated travel platform may integrate an accommodation and/or an experience digital framework which may greatly increase utility and expand the user base for the integrated travel platform, while democratizing the travel industry. As such, the digital framework may allow travel accommodation and/or experience service providers to participate proactively and/or reach out to niche traveler profiles specific to at least one user based on the following, including but not limited to, interests, health conditions, family circumstances, cultural considerations, and/or experiences that travelers or traveler groups seek.

### CROSS-REFERENCE TO RELATED APPLICATIONS

This nonprovisional application claims priority to U.S. Provisional Patent Application No. 63/436,780 entitled “SYSTEM OF AND METHOD FOR PERSONALIZED HEALTH-BASED TRAVEL” filed Jan. 3, 2023 by the same inventors, all of which is incorporated herein by reference, in its entirety, for all purposes.

### BACKGROUND OF THE INVENTION

### 1. Field of the Invention

This invention relates, generally, to travel planning. More specifically, it relates to a system of and method for searching, providing, and/or booking a travel itinerary based on personalized health assessments.

### 2. Brief Description of the Prior Art

The travel and tourism industry are a highly competitive and collaborative market space. Travelers must make complex decisions based on constantly changing situations including but not limited to health condition, hyper local and regional changes, transportation options, cost, duration, group dynamics, climate, and many other factors. Additionally, organizations large and small are extremely protective about their data while they seek to collectively promote their region as a favorable destination.

Moreover, research shows that over 60 million Americans might be more inclined to travel if their disability needs are addressed in the planning stages of the travel. For this niche group of travelers, however, existing travel platforms often do not cater to the health and/or disability needs of the users. Instead, existing technologies typically aggregate and present travel, stay and activity options. The existing technologies are not true personalized decision support systems that address the time, mitigate risk, and enhance safety along with travel experience.

Furthermore, existing technologies are limited in the ability to ingest the variety and volume of data to generate a potential score which may be correlated with travel planning experience. In this manner, the existing technologies fail to implement and/or utilize a blockchain-based system configured to democratize the travel industry. In addition, existing technologies fail to provide any and all non-hedonic incentives such as meals plans, stay and services specific to disease conditions, such as senior living homes and other such targeted demographics.

Accordingly, what is needed is an integrated, accessible, and efficient integrated travel platform. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a computing device-implemented method for providing and/or booking a personalized health travel itinerary. In an embodiment, the computer-implemented method may comprise the following steps: (a) providing, via a computing device having at least one processor, a plurality of safety topics on a display device associated with the computing device; (b) receiving, via at least one user interface communicatively coupled to the computing device, a set of parameters from at least one user based on at least one of the plurality of safety topics; (c) narrowing a plurality of travel packages based on the received set of parameters; (d) presenting the narrowed plurality of travel packages to the user; and (e) automatically booking in real-time, via the at least one processor of the computing device, at least one travel package selected by the user from the presented plurality of narrowed travel packages by: (i) based on a determination that the at least one selected travel package is available and/or comprises accurate pricing, providing, in real-time, a notification to the user indicative of a successful booking of the at least one selected travel package; and (ii) based on a determination that the at least one selected travel package is not available and/or does not comprise accurate pricing, providing, in real-time, a notification to the user indicative of an unsuccessful booking of the at least one selected travel package and/or presenting an updated plurality of travel packages to the user based on the received set of parameters.

In some embodiments, the computing device may also be communicatively coupled to at least one ARI and/or at least one API. In these other embodiment, the computing device-implemented method may further comprise the step of, receiving a pricing and/or an availability of the at least one selected travel package, in real-time. In this manner, the computing device-implemented method may also then comprise the step of, validating a pricing and/or an availability of the presented plurality of travel packages based on the determined real-time pricing and/or availability of the plurality of travel packages, via the at least one ARI and/or the at least one API. In these other embodiments, the computing device-implemented method may then further include the step of, updating the pricing and/or the availability of the presented plurality of travel packages to the real-time pricing and/or availability of the plurality of travel packages.

In some embodiments, the computing device-implemented method may also comprise the step of, presenting, via the display device associated with the computing device, a booking summary to the at least one user. In these other embodiments, the booking summary may comprise at least one booking metric, such that the at least one booking metric may include, but is not limited to a travel location, a room selection, air travel, events, activities, cancellation terms, refund terms, and/or a combination of thereof. As such, the computing device-implemented method may further comprise the step of, subsequent to automatically booking the at least one selected travel package, presenting, via the display device associated with the computing device, an acceptance page to the user, such that the acceptance page may confirm successful booking of the at least one selected travel package.

In some embodiments, the computing device-implemented method may further comprise the step of, determining, via at least one multifactorial algorithm and/or at least one causal algorithm, a safety score for each presented travel package based on the set of parameters provided by the at least one user. In these other embodiments, the safety score may comprise a data model based on an amount of crime and/or vulnerable subpopulations within an area about each of the plurality of travel packages. In this manner, the step of providing a plurality of safety topics to the user of the computing-device implemented method, may further comprise the step of, displaying, via the display device associated with the computing device, a colored map comprising the safety scores for each of the plurality of presented travel packages, such that the colored map may comprise a range of colors corresponding to a range of low safety scores to high safety scores.

In some embodiments, the notification indicative of successful booking and/or an unsuccessful booking may comprise a stimulus including but not limited to auditory, haptic, visual, and/or a combination of thereof.

Moreover, another aspect of the present disclosure pertains to a personalized travel health itinerary optimization system for automatically providing and/or booking a personalized health travel itinerary. In an embodiment, the personalized travel health itinerary optimization system may comprise the following: (a) a computing device having at least one processor, such that the at least one processor may be communicatively coupled to a display device; and (b) a non-transitory computer-readable medium operably coupled to the processor, the computer-readable medium having computer-readable instructions stored thereon that, when executed by the processor, cause the personalized travel health itinerary optimization system to automatically provide and/or book the personalized health travel itinerary, the personalized travel health itinerary by executing instructions comprising: (i) providing, via a computing device having at least one processor, a plurality of safety topics on a display device associated with the computing device; (ii) receiving, via at least one user interface communicatively coupled to the computing device, a set of parameters from at least one user based on at least one of the plurality of safety topics; (iii) narrowing a plurality of travel packages based on the received set of parameters; (iv) presenting the narrowed plurality of travel packages to the user; and (v) automatically booking in real-time, via the at least one processor of the computing device, at least one travel package selected by the user from the presented plurality of narrowed travel packages by: (A) based on a determination that the at least one selected travel package is available and/or comprises accurate pricing, providing, in real-time, a notification to the user indicative of a successful booking of the at least one selected travel package; and (B) based on a determination that the at least one selected travel package is not available and/or does not comprise accurate pricing, providing, in real-time, a notification to the user indicative of an unsuccessful booking of the at least one selected travel package and/or presenting an updated plurality of travel packages to the user based on the received set of parameters.

In some embodiments, the computing device may also be communicatively coupled to at least one ARI and/or at least one API. In these other embodiment, the executed instructions may further comprise the step of, receiving a pricing and/or an availability of the at least one selected travel package, in real-time. In this manner, the executed instructions may also then comprise the step of, validating a pricing and/or an availability of the presented plurality of travel packages based on the determined real-time pricing and/or availability of the plurality of travel packages, via the at least one ARI and/or the at least one API. In these other embodiments, the executed instructions may then further include the step of, updating the pricing and/or the availability of the presented plurality of travel packages to the real-time pricing and/or availability of the plurality of travel packages.

In some embodiments, the executed instructions may further comprise the step of, determining, via at least one multifactorial algorithm and/or at least one causal algorithm, a safety score for each presented travel package based on the set of parameters provided by the at least one user. In these other embodiments, the safety score may comprise a data model based on an amount of crime and/or vulnerable subpopulations within an area about each of the plurality of travel packages. In this manner, the step of providing a plurality of safety topics to the user of the executed instructions, may further comprise the step of, displaying, via the display device associated with the computing device, a colored map comprising the safety scores for each of the plurality of presented travel packages, such that the colored map may comprise a range of colors corresponding to a range of low safety scores to high safety scores.

Furthermore, in some embodiments, the present invention pertains to an integrated travel platform configured to expand the reach (e.g., user base and/or user roles) and/or depth (location, accommodation, and/or experience) of a standard travel booking platform. In an embodiment, the integrated travel platform may comprise at least one service matching algorithm, at least one decision based algorithm, and/or a blockchain-based transaction system to facilitate the minting, transfer, purchase, lease, and/or sale of at least one digital token to facilitate travel planning, review, and/or transaction efficiency of the integrated travel platform for at least one user. Additionally, in these other embodiments, the integrated travel platform may be configured to measure the level of trust of the at least one user and/or a plurality of service providers based on at least one review provided by the at least one user and/or the amount of digital tokens generated and/or provided to the at least one user and/or the plurality of service providers. As such, the integrated travel platform may be configured to build confidence and/or continually improve trust of the at least one user in all aspects of the integrated travel platform.

As such, in some embodiments, the integrated travel platform may be configured to integrate and/or implement a substantial variety and/or volume of data to generate a score that can be correlated with travel planning experience.

Furthermore, in some embodiments, the integrated travel platform may comprise a display device, such that the display device is configured to show the layout (e.g., colored range map) which may have been developed and/or integrated with an algorithm. In addition, in these other embodiments, the at least one service matching algorithm of the integrated travel platform may be extended to include, but is not limited to, climatic, medical, political, and/or interpersonal relational features that may impact an outcome of travel satisfaction of the at least one user. In this manner, at least one curated data set may be extended to health records and/or social media to further personalize the recommendations.

In some embodiments, the integrated travel platform may comprise at least one a travel planning website and/or service, such that the at least one travel planning website and/or service may be configured to cater to the needs of various populations and/or subgroups with specific vulnerabilities. These vulnerabilities may include but are not limited to compromised immune systems, diabetic conditions, allergies, regional and local cuisine, food preferences, and/or religious groups focused on certain types of experiences.

In addition, in some embodiments, the integrated travel platform may also be configured to integrate and/or correlate a city-level matter data, for example, such as the size of city facilities available in the city transportation network built into the city mode of transportation within the city, social services, and/or other travel-related themes. In this manner, the city-level matter data may be provided by the at least one user by the integrated travel platform based on a particular designated travel location, along with specific travel-related microservices such as hotel rooms, Airbnb, specialty chefs, home-based care, dedicated travel agents, and/or Mom and Pop services, based on a plurality of travel topics inputted into the integrated travel platform by the at least one user. As such, in these other embodiments, the services center on specific traveler needs along with geographic and temporal features such as weather patterns, pollution, temperature, and/or humidity, all of which may impact experience and satisfaction that may change over time.

In some embodiments, the integrated travel platform may be configured to provide a city leadership consulting services, such that the city leadership may be provided at least one recommendation by the integrated travel platform on how the city leadership might be able to monetize certain specific groups of travelers and/or position at least one fragmented travel service network provider as leaders in catering to the needs of specific vulnerable groups. Additionally, in these other embodiments, the integrated travel platform may, through its network of vulnerable population groups and health associations, promote via quantitative recommendation engine, destinations, and/or travel service networks tokenized on the blockchain-based transaction system to potential tourists and potential consumers of those services, the vulnerable patients.

In this manner, the integrated travel platform may be configured to invite at least one user with at least one medical health issue to register into the memory of the integrated travel platform and/or create a profile specific to the at least one user within the memory of the integrated travel platform. In addition, in some embodiments, at least one of the plurality of service providers may also be invited by the integrated travel platform to register within the memory of the integrated travel platform and/or create a profile specific to each of the plurality of service providers. In these other embodiments, the plurality of service providers may include but are not limited to medical and/or alternative life support service providers, such as cooks' daily care. As such, in some embodiments, when the profile specific to the at least one user and/or to at least one of the plurality of service providers has been created, the service matching algorithm of the integrated travel platform may be configured to match appropriate groups of service providers to at least one need of the at least one user and/or the integrated travel platform may be configured to provide at least one recommendation to the at least one user and/or at least one of the plurality of service providers, such that the challenge of planning, traveling, and/or making selections of the at least one user may be substantially reduced, optimizing the travel booking process.

Additionally, in some embodiments, the integrated travel platform may enable at least one of the plurality of service providers to build collaborative networks to serve specific groups of travelers with particular interests and limitations. Moreover, in these other embodiments, the integrated travel platform may comprise at least one intuitive user-interface and/or display device, such that the display device may be configured to present a score computed by a multifactorial artificial intelligence (hereinafter “AI”) of the integrated travel platform based on a decision support algorithm which draws data sets from curated public and private data sources in real time basis. In addition, the decision support algorithm of the integrated travel platform may be configured to factor at least one individualized preference of the at least one user into the score presented to the at least one user.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a flow diagram of modules for an integrated travel platform, according to an embodiment of the present disclosure.

FIG. 2 is an exemplary process flow diagram depicting a method of digitally booking a travel safety itinerary and providing real-time recommendations, availability and prices in order to aid a user's travel booking performance, according to an embodiment of the present disclosure.

FIG. 3 is an exemplary architecture diagram of an integrated travel platform, according to an embodiment of the present disclosure.

FIG. 4 depicts an exemplary configuration of a user-interface of an integrated health travel platform, according to an embodiment of the present disclosure.

FIG. 5 depicts an exemplary configuration of a health preference profile of an integrated health travel platform, according to an embodiment of the present disclosure.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements.

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

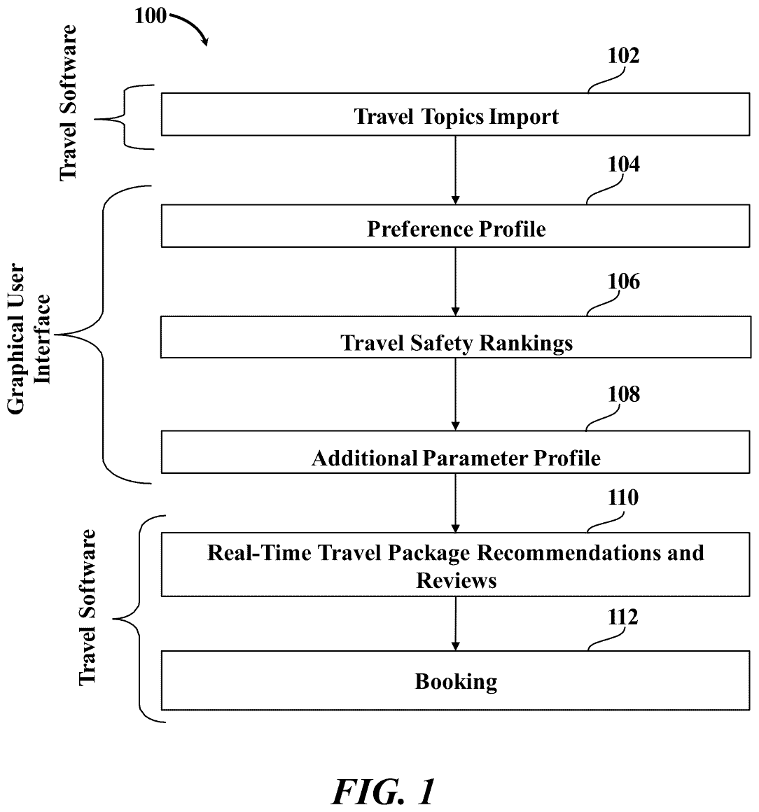

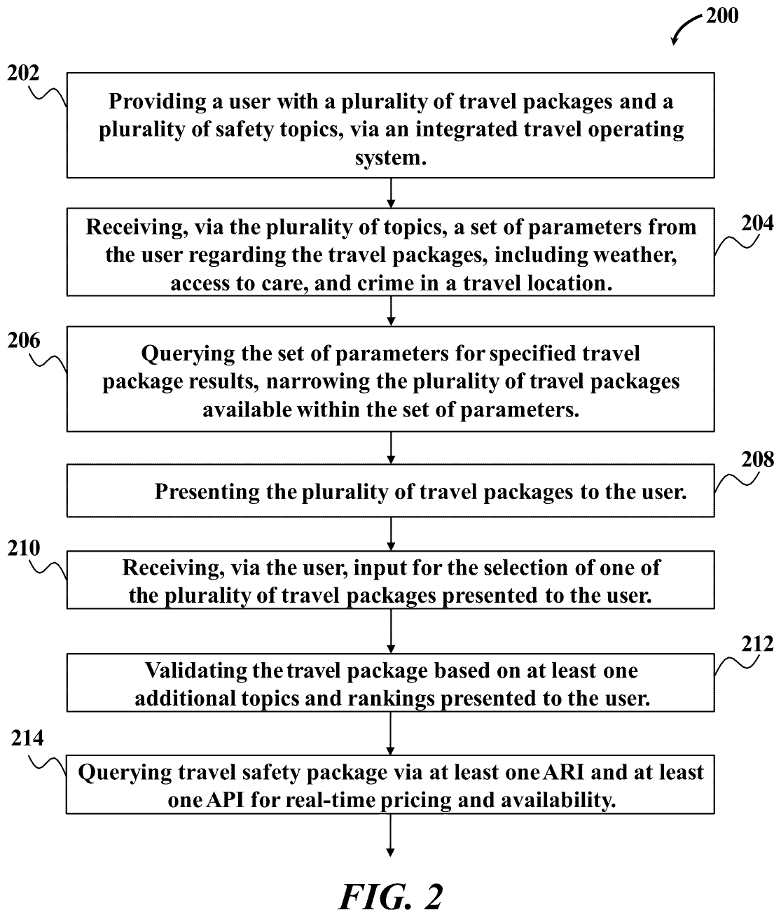

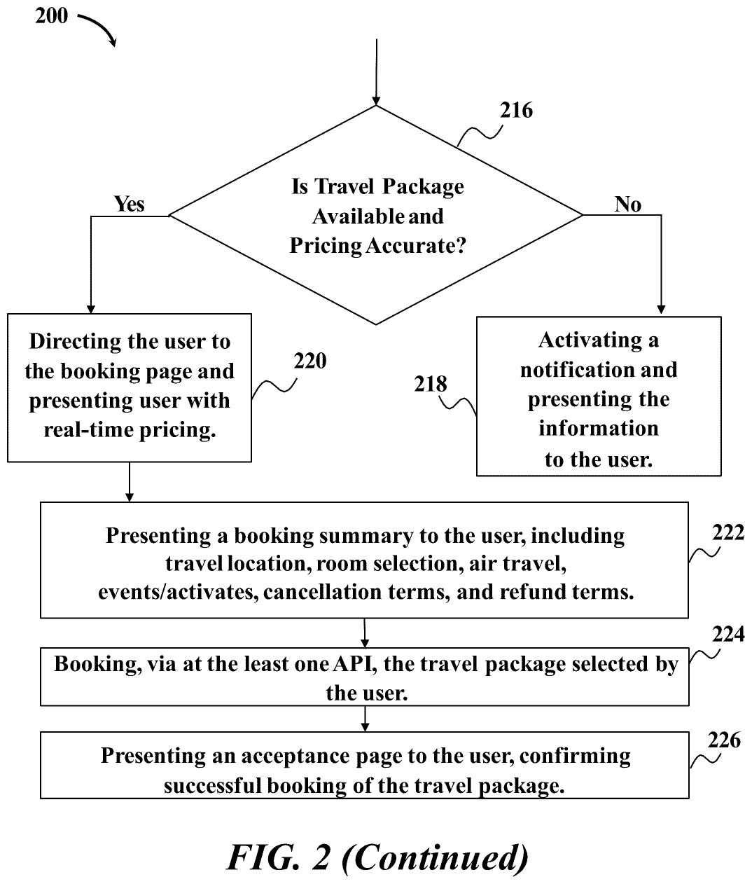

Accordingly, the relevant descriptions of such features apply equally to the features and related components among all the drawings. For example, any suitable combination of the features, and variations of the same, described with components illustrated in FIG. 1, can be employed with the components of FIG. 2, and vice versa. This pattern of disclosure applies equally to further embodiments depicted in subsequent figures and described hereinafter. It should be understood that the figures presented are not meant to be illustrative of actual views of any particular portion of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program PIN embodied on a computer readable medium may be transmitted using any appropriate medium, including but not limited to wireless, wire-line, optical fiber cable, radio frequency, etc., or any suitable combination of the foregoing. Computer program PIN for carrying out operations for aspects of the present invention may be written in any combination of one or more programming languages, including an object oriented programming language such as Java, C #, C++, Python, MATLAB, and/or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, the term “communicatively coupled” refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system), (e.g., the degree of precision required for a particular purpose, such as generating and/or booking a personalized health travel itinerary). As used herein, “about,” “approximately,” or “roughly” refer to within +25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Integrated Travel Platform

The present invention pertains to an integrated travel platform which may incorporate ARI and/or API software. The integrated travel platform may include an integrated platform-such as a website, a mobile application, and/or any software known in the art applicable to any computing device known in the art—that may interact with user through at least one graphical user interface, and/or may provide the user, with a significantly eased travel searching and/or booking experience through the at least one travel package, removing any need to personally plan, explore, and/or book individual components of the desired vacation, business trip, and/or travel itinerary based on at least one personalized safety preference of the user. As such, in an embodiment, the integrated travel platform may comprise a computing device having at least one processor, at least one user interface, and/or at least one display device associated with the computing device.

In an embodiment, the integrated travel package platform may selectively verify and/or cache at least one travel topic (hereinafter “safety topic”). As such, the integrated travel platform, via API, may be configured to perform at least one inquiry for a specified safety topic of the user and/or may import any associated data of the specified safety topic (e.g., personalized user safety standards, user travel satisfaction, at least one destination, user travel recommendations, travel package reviews, and/or at least one user consideration) into a local dataset within the computing device. Subsequently, in this embodiment, the integrated travel package platform may also be configured to cache the ARI of the at least one safety topic and/or save all imported data within the local data set. Furthermore, the integrated travel package platform may also be configured to associate certain preference profiles with the at least one safety topic, allowing the user, via the at least one processor of the computing device, to find the at least one safety topic via selecting the certain preference profiles.

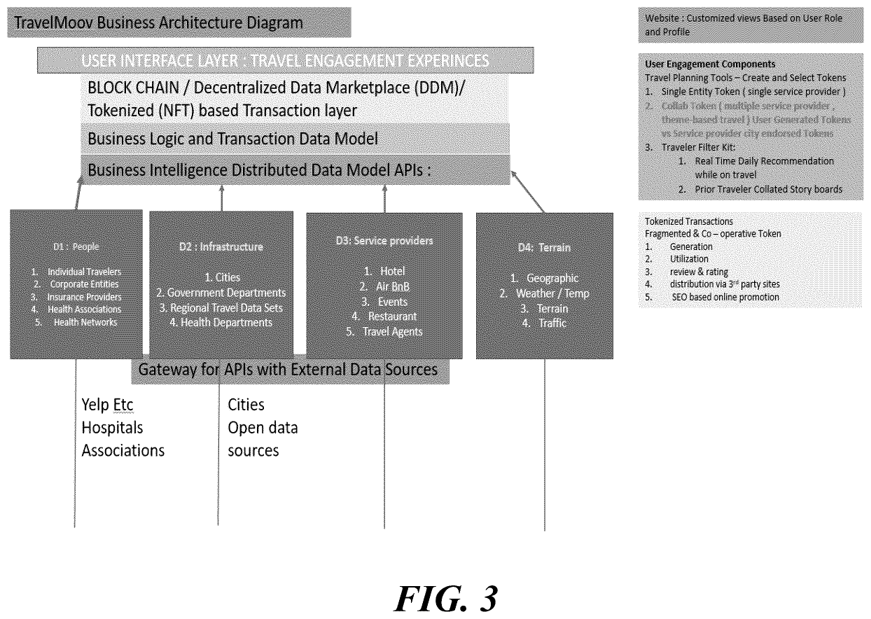

FIG. 1, in conjunction with FIG. 3, depicts a flow diagram of modules for the integrated travel platform, according to an embodiment of the present disclosure. In an embodiment, the integrated travel package platform 100 may include several aspects within the system. In these embodiments, the integrated travel platform 100 may have a safety topics import aspect 102, a preference profile aspect 104, a travel safety rankings aspect 106, an additional parameter profile aspect 108, a real-time safety package recommendation, review and/or pricing aspect 110, and/or a booking aspect 112. In this embodiment, the safety topic import 102, the real-time safety package availability, recommendations, reviews, and/or pricing aspect, and/or the booking aspect 112 are primarily software based only. The preference profile aspect 104, the safety packages aspect 106, and additional parameter profile aspect 108 allow a user to interact with the integrated travel platform 100, via the graphical user interface of a computing device. Each of these aspects will be further described in the other sections of this patent document.

FIG. 2 depicts an exemplary process flow diagram depicting a method of digitally providing and/or booking a travel package on a computing device and providing real-time availability and prices of the travel package in order to aid a user's travel booking performance, according to an embodiment of the present disclosure. As such, the steps delineated in FIG. 2 are merely exemplary of an order of digitally searching and/or booking the travel package on the computing device. The steps may be carried out in another order, with or without additional steps included therein.

As shown in FIG. 2, in an embodiment, method 200 begins at step 202, in which the integrated travel platform may provide the user with a plurality of travel packages and/or a plurality of safety topics. In this manner, this step may include communicatively coupling a blockchain-based transaction system, ARI, and/or API to the integrated travel platform, such that the integrated travel platform may be configured to search and/or cache data of the plurality of safety topics within the travel package. In some embodiments, the integrated travel platform may comprise the blockchain-based transaction system, ARI, and/or API within the software of the integrated travel platform to search and/or cache data of the plurality of safety topics within the travel package.

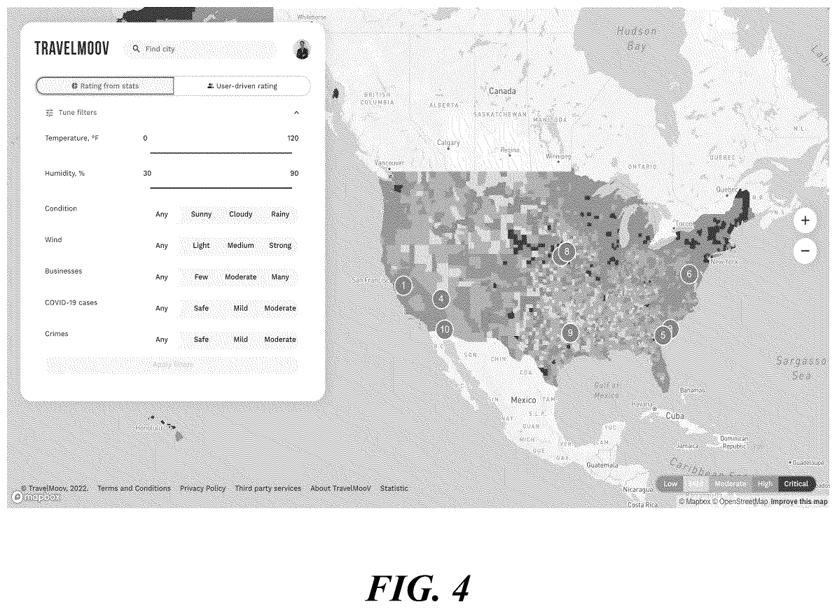

Next, as shown in FIG. 2, in conjunction with FIG. 4, at step 204, the integrated travel platform may be configured to receive, via the plurality of safety topics, at least one parameter from the user regarding the at least one travel package. In an embodiment, the set of parameters from the user may include, but is not limited to, weather, pollution, social safety and/or transport, access to care, access to facilities, entertainment options, therapy, home-based care, community work availability, event planner availability, and/or meal provider availability.

In addition, in an embodiment, the integrated travel platform may also comprise at least one memory (e.g., distributed ledger) associated with the computing device, such that the integrated travel platform may be configured to automatically capture, in real-time, at least one disease condition of at least one travel location based on the at least one parameter from the user. Accordingly, in this embodiment, the integrated travel platform may update the profiles of the traveler and/or the service provider and/or suggest at least one travel package within the travel location selected by the user and/or at least one alternative travel package within at least one alternative travel location comprising similar features as defined by the at least one parameter provided by the user, based on the real-time disease condition of the travel location selected by the user.

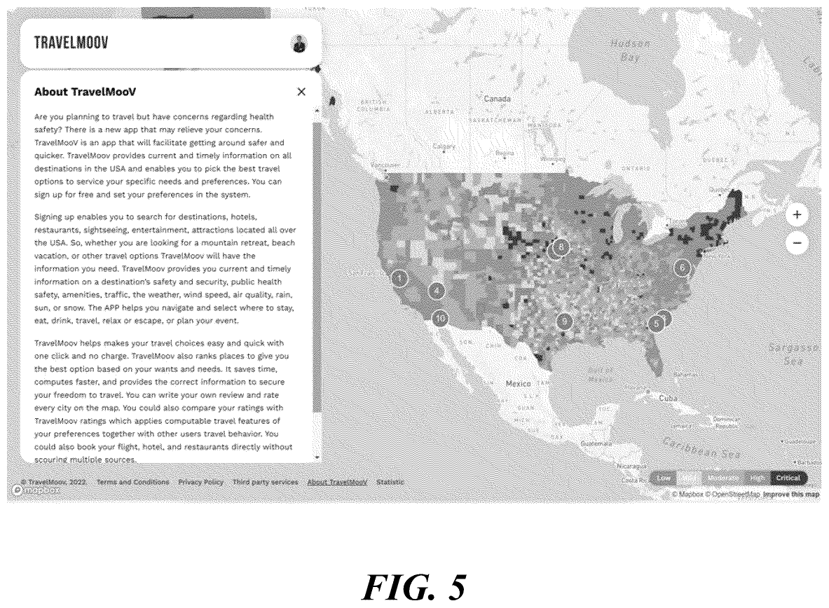

Further, as shown in FIG. 2, at step 206 of method 200, in an embodiment, the integrated travel platform may be configured to query the set of parameters for certain travel package results that may be closely related to the plurality of safety topics selected by the user. In this embodiment, as shown in FIG. 2, in conjunction with FIG. 5, at step 208, the plurality of travel packages may be presented to the user via the interface of the computing device. In this manner, the plurality of travel packages presented to the user may be automatically narrowed based on the set of parameters provided by the user.

Accordingly, in an embodiment, method 200 may proceed to step 208, in which a score may be presented to the user. As such, in this embodiment, the score may comprise an overall safety rating of the travel package based on the at least one safety parameter selected by the user and/or integrated into the set of the at least one parameter from the user. Moreover, the integrated travel platform may comprise at least one multifactorial AI configured to automatically draw at least one data set from at least one curated public and/or private data source in real-time. In addition, the multifactorial AI may also be configured to factor in at least one alternative preference of the user based on at least one secondary safety topic provided by the user in the set of the at least one parameter provided by the user for the travel package. As such, the multifactorial AI may calculate and/or rank at least one travel location from optimally suited to worst-suited based on the at least one preference and/or at least one alternative preference inputted into the integrated travel platform via the user.

Furthermore, in an embodiment, the integrated travel platform may comprise at least one optimized recommendation engine algorithm, such that the at least one recommendation engine algorithm may comprise item-to-item collaborative filtering, user-to-user collaborative filtering and/or content-based filtering based on prior associated data inputted by the at least one user and/or at least one alternative user, with respect to the at least one safety parameter. In this manner, the integrated travel platform, via the at least one recommendation engine algorithm, may be configured to train and/or retrain the prior associated data with inputted data provided by the at least one user (e.g., a multi-stakeholder system), such that the integrated travel platform may minimize data preprocessing required and/or leverage the at least one recommendation engine algorithm and/or transfer learning models, improving recommendations and variety of services recommended to the at least one user based on the at least one safety parameter.

Additionally, in an embodiment, the integrated travel platform may be configured to facilitate a democratization of travel and/or provide optimized travel package recommendations to the at least one user by incorporating at least one collaborative filtering algorithm within the at least one recommendation engine algorithm. Accordingly, in this embodiment, the integrated travel platform may be configured to allow at least one service provider and/or at least one alternative travel recommendation platform may import an associated dataset into the integrated travel platform, reducing the barriers imposed by big data capitalism. In this manner, the at least one collaborative filtering algorithm may be configured to incorporate the associated dataset provided by the at least one service provider and/or at least one alternative travel recommendation platform to train and/or retrain the prior associated data, such that the integrated travel platform may optimize travel package recommendations for the at least one user.

Referring again to FIG. 2, in an embodiment, following presenting the plurality of travel packages to the user, in an embodiment, at step 210 of method 200, the integrated travel platform may receive at least one input for the selection of one of the plurality of travel packages presented to the user. In this embodiment, when the user selects one of the plurality of the travel packages, the user may be sent to the booking page. However, before the user is sent to the booking page, at step 212 of method 200, respectively, the integrated travel platform may present at least one additional parameter to the user to verify the availability of the travel package to the user. As such, in this embodiment, the additional parameters may include, but not limited to, age, allergies, total amount of users that have selected a same and/or a similar travel package, and/or at least one review and/or rating by at least one former traveler. Accordingly, the integrated travel platform may be configured to allow the user to interact with the graphical user interface, such that the user may compare at least one review and/or rating of a former traveler with at least one review and/or rating of the user.

As shown in FIG. 3, in an embodiment, the integrated travel platform may also be used without any personalized information. However, the user may want to personalize each experience, keep travel filter settings, and/or a history which requires a user account associated with the integrated travel platform based on the preferences of the user. Accordingly, in this embodiment, the user authentication may be through the at least one API (e.g., Google Static API). Furthermore, the integrated travel platform may be configured to filter at least one safety topic based on quantitative and/or qualitative aspects and/or ranges. For example, in some embodiments, the filter may be based on Temperature (e.g., Quantitative), Humidity (e.g., Quantitative), and/or subsequent to filtering based on quantitative aspects, the integrated travel platform may then quartile ranges based on the distribution of scores reported by API for Wind, infectious disease (e.g., Covid-19) prevalence, personalized risk (e.g., based on health information provided by a user), and/or Crimes. Additionally, in some embodiments, the integrated travel platform may classify quantitative aspects within a plurality of search terms, for example, weather may be classified using search terms, including but not limited to “any”, “Sunny” “Cloudy” and/or “Rainy” that can be served by API.

Moreover, in an embodiment, as shown in FIG. 3, the integrated travel platform may be configured to track a rating of at least one user account when the at least one user logs into the integrated travel platform. Additionally, in this embodiment, the integrated travel platform may provide at least one rating on a location, which may be comprised of an average at least one alternative rating by each user and/or alternative user.

Additionally, in an embodiment, the integrated travel platform may be configured to backend at least one query from the user and/or various data sources. In this manner, in this embodiment, the at least one query may occur on a daily basis and/or any timeframe known in the art associated with updating a database and/or the integrated travel platform may be configured to save the results to a memory of the computing device associated with the integrated travel platform. As such, any information saved to the memory of the computing device of the integrated travel platform may be displayed on a display device associated with the computing device (e.g., infectious disease (e.g., Covid-19) prevalence information and/or personalized risk score and/or ranking every day at 07:00 AM/PM, mobility information every day at 08:00 AM/PM, yelp data every day at 09:00 AM/PM, crime data at 06:00 AM/PM on Mondays, and/or weather data every day at 05:00 AM/PM).

Moreover, in an embodiment, the integrated travel platform may be configured to integrate a new travel package, via the at least one multifactorial AI and/or blockchain-based transaction system, based on the at least one additional parameter selected by the user. In this manner, the multifactorial AI may be configured to retain at least one parameter provided by the user in a memory of the computing device, such that the integrated travel platform may provide the user with a travel behavior based on past user selections, including but not limited to, at least one safety topic, at least one parameter, and/or at least one travel package.

Accordingly, as shown in FIG. 3, in an embodiment, the at least one multifactorial AI of the integrated travel platform may comprise at least one specific machine learning algorithm and/or at least one causal model, such that the integrated travel platform may be configured to continually learn from travel experience outcomes of the at least one user based on reviews and/or at least one digital token used. In this manner, the integrated travel platform may provide at least one recommendation to the fragmented travel service provider network in a designated travel location, based on the travel safety topics provided by the at least one user, on how at least one of the plurality of service providers may better align at least one service for the at least one user (e.g., a specific population of interest). For example, in some embodiments, if a diabetic association wants to have a conference in Orlando, the integrated travel platform may provide the at least one recommendation to the travel service provider network of a specific area and/or location (e.g., city, state, and/or country) (e.g., Orlando) to cater to the unique needs of a large number exceeding 3000 to 4000 diabetic patients. As such, in these other embodiments, the at least one recommendation may include making foot specialists available for diabetic foot-related issues, culinary services, events in destinations and/or theme parks that cater to the needs of the at least one user, and/or ensuring the services of the at least one of the plurality of service providers may be aligned with the needs of the at least one user.

Therefore, as shown in FIG. 4 and FIG. 5, in an embodiment, a data model, as provided below in equation (1), of the integrated travel platform may be configured to integrate at least one additional data point and/or remove at least one data point as the integrated travel platform updates and/or includes at least one additional vulnerable subpopulations and/or at least one additional service provider. Furthermore, in this embodiment, the integrated travel platform may be configured to educate the at least one of the plurality of service providers on how to cater to the needs of the newly included at least one additional vulnerable subpopulation within at least one of a plurality of designated travel locations. As such, the data model is provided below:

$${S}_{S} = {P}_{S} * 2 + {C}_{S} * 0.54 + {B}_{S} * 0.35 + {CM}_{S} * 0.11 \qquad ( 1 )$$

As provided in the equation above S_{S} represents a total safety score of the data model; P_{S} represents a Population Score; C_{S} represents an Infectious Disease (e.g., Covid-19) Prevalence Aggregate Risk Score; B_{S} represents a Personalized Risk Score, and CM_{S} represents a crime score.

Accordingly, in an embodiment, the Population Score may be calculated by population of the city; the Infectious Disease Prevalence Aggregate Risk Score may be calculated as a total sum of new cases of at least one infectious disease for a city's county. For example, in some embodiments, the Infectious Disease Prevalence Aggregate Risk Score may be calculated over the past 14 days normalized per 100,000 county population. In addition, the Personalized Risk Score may be calculated as the sum of a predetermined amount of city businesses normalized per a predetermined amount of a city population. For example, in some embodiments, the Personalized Risk Score may be calculated as a total sum of city businesses normalized per 100,000 city population. Moreover, the Crime Score may be calculated as the number of crimes for the city normalized per the predetermined city population. For example, in some embodiments, the Crime Score may be calculated as the total number of crimes for the city normalized per 100,000 city population. Additionally, as shown in FIGS. 4-5, in an embodiment, the ranges of the safety score may be presented as different colors on a travel safety map. As such, the ranges for the for the safety score may be defined dynamically and/or the ranges for the safety score of the data model may depend on the actual values at the specific moment of the time.

Accordingly, in an embodiment, the integrated travel platform may comprise a personalized mode, in which the personalized mode comprises a total safety score as determined by the user defined categories and/or ranges (e.g., travel safety topics). In this manner, the personalized mode for the at least one user may be presented only when the at least one user may be logged into the specific profile associated with the at least one user within the memory of the integrated travel platform. Accordingly, in this embodiment, when the user returns to the integrated travel platform, the integrated travel platform may be configured to provide the user with a notification comprising and/or indicative of at least one travel package based on the travel behavior of the user, via the multifactorial AI.

Moreover, in an embodiment, as stated above, the blockchain-based transaction system of the integrated travel platform may be configured to facilitate a minting, transfer, purchase, lease, and/or sale of at least one digital token (e.g., Non-Fungible Token (hereinafter “NFT”)). For example, in some embodiments, the integrated travel platform may be configured to mint, transfer, purchase, lease, and/or sale at least one Collab Token and/or at least one Evaluation Token. Accordingly, as shown in FIG. 3, in these other embodiments, the at least one multifactorial AI and/or blockchain-based transaction system of the integrated travel platform may comprise at least one service matching algorithm, such that the at least one multifactorial AI and/or blockchain may connect the user with at least one service provider. In this manner, the at least one service matching algorithm may be configured to create at least one innovative data architecture, such that the at least one service matching algorithm may be configured to combine at least one data microservice for each data shape and/or data type (e.g., infectious disease (e.g., Covid-19) prevalence and/or cases and/or personalized risk within an area, hotel and/or rental vehicle availability).

Additionally, in an embodiment, the at least one blockchain-based transaction system may be configured to allow the at least one service provider to tokenize each service the at least one service provider offers across any time. In addition, in this embodiment, the blockchain-based transaction system may be configured to enable the user of those services to purchase at least one reserve trade. As such, the tokenized services may comprise an efficient and/or transparent way that may build trust in the integrated travel platform based on a rich feature set of attributes.

In this manner, in an embodiment, as shown in FIG. 3, the at least one digital token may be used by the user to facilitate travel planning, review, rating, transaction efficiency, booking, and/or any travel aspect known in the art related to travel planning, reviewing/rating, and/or booking. As such, the integrated travel platform may be configured to measure and/or determine the level of trust amongst all users comprising the at least one digital token. Accordingly, in this embodiment, the multifactorial AI may be configured to implement the level of trust, to verify an accuracy of the at least one travel package, and/or suggest continued selection of the at least one travel package to at least one of the plurality of users of the integrated travel platform.

In an embodiment, the integrated travel platform may also be configured to generate at least one digital token (hereinafter “Collab Token”), such that at least one group of a plurality of service providers within a designated travel location, as determined by the at least one user and/or the integrated travel platform, with an alignment of services that cater to tourists with specific needs and/or profiles based on the at least one travel safety topic selected by the at least one user. Furthermore, in this embodiment, the integrated travel platform may be configured to determine how many Collab Tokens have been generated and/or provided to the at least one group of the plurality of service providers. In this manner, the integrated travel platform may be configured to determine a level of collaboration within the at least one group of service providers based on the at least one Collab Token issued to the at least one group of the plurality of service providers.

As such, in an embodiment, the memory of the integrated travel platform may comprise at least one set of collaboration parameters (e.g., quick validation of travel package, group booking of airfare and rental vehicles), such that when the at least one group of the plurality of service providers successfully meets at least one of the set of collaboration parameters, the at least one group of the plurality of service provides may be provided at least one Collab Token by the integrated travel platform. Additionally, this embodiment, based on the total amount of Collab Tokens generated for the at least one group of the plurality of service providers, the integrated travel platform may be configured to incentivize, validate, and/or endorse the at least one group of the plurality of service providers within the designated travel location (e.g., city, state and/or regional government).

Accordingly, in an embodiment, the integrated travel platform may also be configured to generate the at least one alternative digital token (hereinafter “Evaluation Token”). The at least one Evaluation Token may be a credit used in place of money for the purpose of making at least one specific and/or special request to at least one of the plurality of service providers in communication with the integrated travel platform. In this embodiment, the integrated travel platform may be configured to offer and/or generate the at least one Evaluation Token for a predetermined cost (e.g., U.S. Dollars). Furthermore, based on the specific and/or special request made by the at least one user to at least one of the plurality of service providers, a detailed specific and/or special request may require a larger amount of Evaluation Tokens as compared to a simple specific and/or special request. Additionally, in this embodiment, the integrated travel platform may be configured to associate an expiration date with the at least one Evaluation Token, such that, after the at least one user pays for the at least one Evaluation Token, the at least one Evaluation Token may be configured to expire a certain number of days before the intended travel date, as selected by the at least one user. For example, in some embodiments, when using the integrated travel platform to book a trip to Las Vegas, a request for a room with at least one King Bed may require less Evaluation Tokens than a request for a room with at least one King Bed with a view of the Las Vegas Strip.

Moreover, in an embodiment, the integrated travel platform may be configured to determine and/or calculate the total amount of Evaluation Tokens generated for the at least one of the plurality of service providers within the designated travel location (e.g., city, state and/or regional government), such that the integrated travel platform may predict and/or forecast demand for the at least one of the plurality of service providers. Accordingly, in this embodiment the integrated travel platform may be configured to increase and/or decrease a total amount of Evaluation Tokens required for the specific and/or special request of the at least one user for the at least one of the plurality of service providers. In addition, the integrated travel platform may be configured to provide at least one destination and/or service recommendation based on the total amount of Evaluation Tokens issued for the at least one of the plurality of service providers within the designated travel location. In this manner, the integrated travel platform may be configured to suggest at least one alternative destination and/or alternative service recommendation to the at least one user after the at least one user has selected a destination and/or service with a lower total amount of Evaluation Tokens than the at least one alternative destination and/or alternative service.

Referring again to FIG. 2, next, at step 214, the integrated travel platform then queries the travel package via the use of the at least one ARI and/or the at least one API to collect and cache the most recent travel safety data topic to determine the real-time pricing and availability of the travel package.

At step 216, as shown in FIG. 2, the integrated travel platform compares the received real-time price and/or availability cached from the at least one ARI and/or the at least one API to the cost and/or availability originally cached from the initial search using the at least one ARI and/or the at least one API. The method then proceeds to either step 218 or step 220 depending on whether a substantial match exists between the real-time price and/or availability and the original price and/or availability. In some embodiments, the integrated travel platform may regularly update the original price at predetermined intervals to maintain accuracy of the real-time availability and/or rates.

During step 218, the integrated travel platform determines that a substantial match does not exist between the real-time price and/or availability of the travel package and the original price and/or availability. As such, during step 218, the integrated travel platform executes instructions to activate a notification, presenting the information to the user. In some embodiments, the integrated travel platform associated with the computing device may verbalize the notification of the integrated travel platform.

During step 220, the integrated travel platform may determine that a substantial match does exist between the real-time price and/or the availability of the travel package and the original availability and/or price. Accordingly, during step 220, the integrated travel platform directs the user to the booking page, presenting the user with the real-time price and/or availability of the travel package.

Furthermore, at step 222 of method 200, in an embodiment, the integrated travel platform presents the user a booking summary on the booking page, including but not limited to room selection, cancellation terms and/or refund terms. In this embodiment, the integrated travel platform may automatically enter the personal and/or the payment information of the user to optimize the booking process for the user. Next, at step 224, the integrated travel platform may be configured to automatically book the aspects of the travel package, via at least one API, using the personal and/or the payment information of the user, increasing the efficiency of the travel booking of the user.

Finally, as shown in FIG. 2, in an embodiment, method 200 may proceed to step 226, in which the integrated travel platform may provide the user with an acceptance page, confirming successful booking of the travel package. In this embodiment, if an issue arises within the booking process, the integrated travel platform may be configured to provide the user a notification of the error and/or, subsequently, with several solutions to alleviate the booking issue. Additionally, in some embodiments, the notification of the error may be provided to the user, via any auditory, tactile, and/or haptic means known in the art by the integrated travel platform, via the at least one processor of the computing device.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A computing device-implemented method for providing, booking, or both a personalized health travel itinerary, the computer-implemented method comprising:
providing, via a computing device having at least one processor, a plurality of safety topics on a display device associated with the computing device;
receiving, via at least one user interface communicatively coupled to the computing device, a set of parameters from at least one user based on at least one of the plurality of safety topics;
narrowing a plurality of travel packages based on the received set of parameters;
presenting the narrowed plurality of travel packages to the user; and
automatically booking in real-time, via the at least one processor of the computing device, at least one travel package selected by the user from the presented plurality of narrowed travel packages by:
based on a determination that the at least one selected travel package is available, comprises accurate pricing, or both, providing, in real-time, a notification to the user indicative of a successful booking of the at least one selected travel package; and
based on a determination that the at least one selected travel package is not available, does not comprise accurate pricing, or both, providing, in real-time, a notification to the user indicative of an unsuccessful booking of the at least one selected travel package, presenting an updated plurality of travel packages to the user based on the received set of parameters, or both.

2. The computing device-implemented method of claim 1, wherein the computing device is communicatively coupled to at least one ARI, at least one API, or both.

3. The computing device-implemented method of claim 2, further comprising the step of, receiving a pricing, an availability, or both of the at least one selected travel package, in real-time.

4. The computing device-implemented method of claim 3, further comprising the step of, validating a pricing, an availability, or both of the presented plurality of travel packages based on the determined real-time pricing, availability, or both of the plurality of travel packages, via the at least one ARI, the at least one API, or both.

5. The computing device-implemented method of claim 4, further comprising the step of, updating the pricing, the availability, or both of the presented plurality of travel packages to the real-time pricing, availability, or both of the plurality of travel packages.

6. The computing device-implemented method of claim 1, further comprising the step of, presenting, via the display device associated with the computing device, a booking summary to the at least one user.

7. The computing device-implemented method of claim 6, wherein the booking summary comprises at least one booking metric selected from the group consisting of a travel location, a room selection, air travel, events, activities, cancellation terms, refund terms, and a combination of thereof.

8. The computing device-implemented method of claim 1, further comprising the step of, subsequent to automatically booking the at least one selected travel package, presenting, via the display device associated with the computing device, an acceptance page to the user, whereby the acceptance page confirms successful booking of the at least one selected travel package.

9. The computing device-implemented method of claim 1, further comprising the step of, determining, via at least one multifactorial algorithm, at least one causal algorithm, or both, a safety score for each presented travel package based on the set of parameters provided by the at least one user.

10. The computing device-implemented method of claim 9, wherein the safety score comprises a data model based on an amount of crime, vulnerable subpopulations, or both, within an area about each of the plurality of travel packages.

11. The computing device-implemented method of claim 10, wherein the step of providing a plurality of safety topics to the user, further comprises the step of, displaying, via the display device associated with the computing device, a colored map comprising the safety scores for each of the plurality of presented travel packages, wherein the colored map comprises a range of colors corresponding to a range of low safety scores to high safety scores.

12. The computing device-implemented method of claim 1, wherein the notification indicative of successful booking, unsuccessful booking, or both comprises a stimulus selected from the group consisting of auditory, haptic, visual, and a combination of thereof.

13. A personalized travel health itinerary optimization system for automatically providing, booking, or both a personalized health travel itinerary, the personalized travel health itinerary optimization system comprising:
a computing device having at least one processor, wherein the at least one processor is communicatively coupled to a display device; and
a non-transitory computer-readable medium operably coupled to the processor, the computer-readable medium having computer-readable instructions stored thereon that, when executed by the processor, cause the personalized travel health itinerary optimization system to automatically provide, book, or both the personalized health travel itinerary, the personalized travel health itinerary by executing instructions comprising:
providing, via a computing device having at least one processor, a plurality of safety topics on a display device associated with the computing device;
receiving, via at least one user interface communicatively coupled to the computing device, a set of parameters from at least one user based on at least one of the plurality of safety topics;
narrowing a plurality of travel packages based on the received set of parameters;
presenting the narrowed plurality of travel packages to the user; and
automatically booking in real-time, via the at least one processor of the computing device, at least one travel package selected by the user from the presented plurality of narrowed travel packages by:
based on a determination that the at least one selected travel package is available, comprises accurate pricing, or both, providing, in real-time, a notification to the user indicative of a successful booking of the at least one selected travel package; and
based on a determination that the at least one selected travel package is not available, does not comprise accurate pricing, or both, providing, in real-time, a notification to the user indicative of an unsuccessful booking of the at least one selected travel package, presenting an updated plurality of travel packages to the user based on the received set of parameters, or both.

14. The personalized travel health itinerary system of claim 13, wherein the computing device is communicatively coupled to at least one ARI, at least one API, or both.

15. The personalized travel health itinerary system of claim 14, wherein the executed instructions further comprise the step of, receiving a pricing, an availability, or both of the at least one selected travel package, in real-time.

16. The personalized travel health itinerary system of claim 15, wherein the executed instructions further comprise the step of, validating a pricing, an availability, or both of the presented plurality of travel packages based on the determined real-time pricing, availability, or both of the plurality of travel packages, via the at least one ARI, the at least one API, or both.

17. The personalized travel health itinerary system of claim 16, wherein the executed instructions further comprise the step of, updating the pricing, the availability, or both of the presented plurality of travel packages to the real-time pricing, availability, or both of the plurality of travel packages.

18. The personalized travel health itinerary system of claim 13, wherein the executed instructions further comprise the step of, determining, via at least one multifactorial algorithm, at least one causal algorithm, or both, a safety score for each presented travel package based on the set of parameters provided by the at least one user.

19. The personalized travel health itinerary system of claim 18, wherein the safety score comprises a data model based on an amount of crime, vulnerable subpopulations, or both, within an area about each of the plurality of travel packages.

20. The personalized travel health itinerary system of claim 19, wherein the step of providing a plurality of safety topics to the user of the executed instructions, further comprises the step of, displaying, via the display device associated with the computing device, a colored map comprising the safety scores for each of the plurality of presented travel packages, wherein the colored map comprises a range of colors corresponding to a range of low safety scores to high safety scores.
